(19) United States
(12) Patent Application Publication
(10) Pub. No.: US 2014/0011096 A1
(43) Pub. Date: Jan. 9, 2014

(54) SODIUM-CHALCOGEN CELL

(71) Applicants: Andre Moc, Grossschoenau (DE); Ulrich Eisele, Stuttgart (DE); Alan Logeat, Stuttgart (DE)

(72) Inventors: Andre Moc, Grossschoenau (DE); Ulrich Eisele, Stuttgart (DE); Alan Logeat, Stuttgart (DE)

(21) Appl. No.: 13/992,664

(22) PCT Filed: Oct. 20, 2011
(86) PCT No.: PCT/EP2011/068284

§ 371 Date: Aug. 14, 2013

(30) Foreign Application Priority Data
Dec. 9, 2010 (DE) 10 2010 062 713.5

(51) Int. Cl. H01M 10/39; H01M 10/38

(52) U.S. Cl. CPC H01M 10/3918; H01M 10/38
USPC 429/320; 429/231.9; 429/211; 429/321; 429/322; 429/319; 29/623.1

(57) ABSTRACT

A sodium-chalcogen cell is described which is operable at room temperature, in particular a sodium-sulfur or sodium-oxygen cell, the anode and cathode of which are separated by a solid electrolyte which is conductive for sodium ions and nonconductive for electrons. The cathode of the sodium-chalcogen cell includes a solid electrolyte which is conductive for sodium ions and electrons. Moreover, a manufacturing method for this type of sodium-chalcogen cell is described.

### FIELD OF THE INVENTION

The present invention relates to a sodium-chalcogen cell and a manufacturing method for this type of cell.

### BACKGROUND INFORMATION

Sodium-sulfur cells are customarily operated at a temperature (−300° C.) at which sulfur and sodium are liquid in order to ensure sufficient conductivity and sufficient transport of sodium ions, as well as sufficient contact between the reactants (sulfur, sodium ions, and electrons). A sulfur-graphite composite is usually used as the cathode material for these types of high-temperature sodium-sulfur cells.

However, sodium-sulfur cells having a sulfur-graphite cathode cannot be operated at room temperature, since the sodium ion conductivity of solid sulfur and graphite is not sufficient. In addition, an irreversible loss of capacity inlay occur due to phase transition when this type of sodium-sulfur cell is repeatedly charged and discharged.

In sodium-sulfur cells, the use of liquid electrolytes may result in the sodium anode reacting with the electrolyte, the electrolytic solvent, or polysulfides, and corroding. In addition, sodium dendrites may form between the electrodes upon repeated charging and discharging, and may short-circuit the cell.

### SUMMARY

The subject matter of the present invention is a sodium-chalcogen cell, in particular a sodium-sulfur cell or a sodium-oxygen cell, which includes an anode (negative electrode) and a cathode (positive electrode), the anode including sodium and the cathode including at least one chalcogen, particular sulfur and/or oxygen. The anode and the cathode are preferably separated by at least one solid electrolyte which is conductive for sodium ions and nonconductive for electrons. In addition, the cathode preferably includes at least one solid electrolyte which is conductive for sodium ions and electrons.

Within the meaning of the present invention, in particular a material may be understood to be conductive for sodium ions Which has a sodium ion conductivity of ≧1·10⁻⁶ S/cm at 25° C. Within the meaning of the present invention, “nonconductive for electrons” may be understood to mean a material which has a sodium ion conductivity of <1-10⁻⁸ S/cm at 25° C.

Separating the anode and cathode by a solid electrolyte which is conductive for sodium ions and nonconductive for electrons has the advantage that short circuits may be prevented in this way. A solid electrolyte which is conductive for sodium ions and electrons as cathode material has the advantage that sufficient sodium ion conductivity may be ensured, even at room temperature. Thus, a solid-based low temperature/(room temperature) sodium-sulfur cell may advantageously be provided. Liquid electrolytes and electrolytes which may possibly be flammable maybe dispensed with. A cell having improved long-term stability and reliability may thus advantageously be provided. Furthermore, a solid electrolyte which is conductive for sodium ions and electrons may at the same time additionally function as a current conductor, so that further additives for increasing the electrical conductivity may be dispensed with and the overall energy density of the cell may be optimized.

Within the scope of one specific embodiment, the cathode includes at least one conducting element composed of a solid electrolyte which is conductive for sodium ions and electrons. Sodium ions as well as electrons may advantageously be transported to the chalcogen reaction partner via this type of conducting element.

The conducting element may be designed, for example, in the folio. of a porous, for example sponge-like, body or in the form of a wire or fiber mesh, for example made of nanowires nanofibers. Nanowires or nanofibers may be understood in particular to mean wires or fibers having an average diameter of ≦500 nm, for example ≦100 nm. However, it is likewise possible for the cathode to include a plurality of conducting elements which are rod-like; plate-like, or grid-like, for example.

Within the scope of another specific embodiment, one section of the conducting element or the conducting elements contacts the solid electrolyte which is conductive for sodium ions and nonconductive for electrons, and another section of the conducting element or the conducting elements contacts a cathode current collector. Good conduction of sodium ions and electrons may be ensured in this way. For example, one section of a conducting element designed in the form of a porous body or wire or fiber mesh may contact the solid electrolyte which is conductive for sodium ions and nonconductive for electrons, and another section of the conducting element designed in the form of a porous body or wire or fiber mesh may contact the cathode current collector.

Within the scope of another specific embodiment, the cathode includes a plurality of conducting elements composed of a solid electrolyte which is conductive for sodium ions and electrons, one section of which in each case contacts the solid electrolyte which is conductive for sodium ions and nonconductive for electrons, and another section of which contacts the cathode current collector. Particularly good conduction of sodium ions and electrons may be ensured in this way. For example, the cathode may include a plurality of fiat or arched plate-shaped or grid-shaped conducting elements situated at a distance from one another, which in each case on the one hand contact the solid electrolyte which is conductive for sodium ions and nonconductive for electrons, and on the other hand contact the cathode current collector. The conducting elements may be situated essentially in parallel to one another. For example, the conducting elements may be situated with respect to one another similarly as for the slats of a Venetian blind. The conducting elements may be situated essentially vertically with respect to the electrolyte which is conductive for sodium ions and nonconductive for electrons, and with respect to the cathode current collector.

Within the scope of another specific embodiment, structures composed of a solid electrolyte which is conductive for sodium ions and electrons are provided on the conducting element(s). As a result of the structures, the surface of the conducting clement, and thus the surface area available for the sodium-chalcogen redox reaction, may advantageously be enlarged. The structures may be, for example, structures in the range of several microns or nanometers.

The conducting elements and structures may be formed from the same or also from different solid electrolytes which are conductive for sodium ions and electrons. In particular, the conducting elements and structures may be formed from the same solid electrolyte which is conductive for sodium ions and electrons.

Within the scope of another specific embodiment, the structures are formed by needle-shaped, for example, solid electrolyte crystals which are conductive for sodium ions and electrons. These types of structures may be provided on the conducting element by hydrothermal synthesis, for example.

Within the scope of another specific embodiment, the solid electrolyte which is conductive for sodium ions and electrons, in particular for conducting elements and/or structures, includes a sodium titanate, in particular which contains trivalent titanium. In particular, the solid electrolyte which is conductive for sodium ions and electrons may be composed of a sodium titanate, in particular which contains trivalent titanium. Within the scope of the present invention, a sodium titanate may be understood to mean a pure sodium titanate as well as a sodium titanate mixed oxide or a doped sodium titanate which includes one or multiple foreign atoms (metal cations other than sodium and titanium), in particular foreign atom oxides, in particular when the total number of foreign atoms is >0% to ≦10%, for example >0% to ≦1%, relative to the number of titanium atoms. Sodium titanates containing trivalent titanium may advantageously have a higher electron conductivity than sodium titanates containing only tetravalent titanium. Therefore, sodium titanates containing trivalent titanium are particularly suited as solid electrolytes which are conductive for sodium ions and electrons.

For a sodium titanate mixed oxide or a doped sodium titanate, the sodium ion conductivity and electron conductivity may advantageously be set by adjusting the type and quantity of is foreign atoms.

In particular, the sodium titanate containing trivalent titanium may be a sodium titanate mixed oxide which contains one or multiple foreign atom oxides selected from the group composed of sodium oxide, lithium oxide, magnesium oxide, calcium oxide, barium oxide, zinc oxide, iron oxide, aluminum oxide, gallium oxide, zirconium oxide, manganese oxide, silicon oxide, niobium oxide, tantalum oxide, and bismuth oxide, or the sodium titanate containing trivalent titanium may be doped with one or multiple foreign atoms selected from the group composed of sodium, lithium, magnesium, calcium, barium, zinc, iron, aluminum, gallium, zirconium, manganese, silicon, niobium, tantalum, and bismuth. For example, the sodium titanate mixed oxide containing trivalent titanium may contain one or multiple foreign atom oxides selected from the group composed of sodium oxide, lithium oxide, magnesium oxide, calcium oxide, barium oxide, manganese(II) oxide, zinc oxide, iron(II) oxide, aluminum oxide, gallium oxide, niobium(III) oxide, manganese(III) oxide, iron(III) oxide, zirconium oxide, manganese(IV) oxide, silicon oxide, niobium(V) oxide, tantalum oxide, and bismuth(V) oxide, or the sodium titanate containing trivalent titanium may be doped with one or multiple foreign atoms selected from the group composed of sodium, lithium, magnesium, calcium, barium, manganese(II), zinc, iron(II), aluminum, gallium, niobium(III), manganese(III), iron(III), zirconium, manganese(IV), silicon, niobium(V), tantalum, and bismuth(V).

Titanium sites in the sodium titanate are preferably occupied by foreign atoms instead of by titanium. For example, titanium(III) sites may be occupied by aluminum, gallium, niobium(III), manganese(III), and/or iron(III), and/or by magnesium, calcium, barium, manganese(II), zinc, and/or iron(II) and zirconium, manganese(IV), and/or silicon, and/or by sodium and/or lithium and niobium(V), tantalum, and/or bismuth(V).

Within the scope of another specific embodiment, the solid electrolyte which is conductive for sodium ions and electrons, in particular for the conducting elements and/or structures, includes a sodium titanate which contains trivalent titanium, in particular a sodium titanate of general formula (1):

Na₂Ti^{IV}ₙ₋ₓTi^{III}ₓO_{2n+1-x/2}:MO,

where 2≦n≦10 and 0≦x≦n, and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide, i.e., Na₂Ti^{IV}ₙ₋ₓTi^{III}ₓO_{2n+1-x/2}, where 2≦n≦10 and 0≦x≦n. In particular, the solid electrolyte which is conductive for sodium ions and electrons may be composed of a sodium titanate of general formula (1). Within the meaning of the present invention, the colon (:) in formula (1), and formula (2), which is explained below, may be understood in particular to mean that in the empirical formula, the titanium oxide may be partially replaced by one or multiple foreign atom oxides (mixed oxide/doping). Sodium titanates which contain trivalent titanium, in particular of general formula (1), have proven to be advantageous as solid electrolytes which are conductive for sodium ions and electrons.

Within the scope of another specific embodiment, the solid electrolyte which is conductive for sodium ions and nonconductive for electrons includes a material selected from the group composed of β-aluminum oxide, in particular textured β-aluminum oxide, sodium titanates tetravalent titanium (only titanium(IV), not titanium(III)), and mixtures, in particular composites, thereof. In particular, the solid electrolyte which is conductive for sodium ions and nonconductive for electrons may be composed of such a material. Textured β-aluminum oxide may be understood in particular to mean a β-aluminum oxide which has a directional structure, for example produced by an electrical and/or magnetic field, in particular for increasing the sodium ion conductivity.

In particular, the sodium titanate of tetravalent titanium may be a sodium titanate mixed oxide which contains one or multiple foreign atom oxides selected from the group composed of sodium oxide, lithium oxide, magnesium oxide, calcium oxide, barium oxide, zinc oxide, iron oxide, aluminum oxide, gallium oxide, zirconium oxide, manganese oxide, silicon oxide, niobium oxide, tantalum oxide, and bismuth oxide, or the sodium titanate of tetravalent titanium may be doped with one or multiple foreign atoms selected from the group composed of sodium, lithium, magnesium, calcium, barium, zinc, iron, aluminum, gallium, zirconium, manganese, silicon, niobium, tantalum, and bismuth. For example, the sodium titanate(IV) mixed oxide may contain one or multiple foreign atom oxides selected from the group composed of sodium oxide, lithium oxide, magnesium oxide, calcium oxide, barium oxide, manganese(II) oxide, zinc oxide, iron(II) oxide, aluminum oxide, gallium oxide, niobium(III) oxide, manganese(III) oxide, iron(III) oxide, zirconium oxide, manganese(IV) oxide, silicon oxide, niobium(V) oxide, tantalum oxide, and bismuth(V) oxide, or the sodium titanate of tetravalent titanium may be doped with one or multiple foreign atoms selected from the group composed of sodium, lithium, magnesium, calcium, barium, manganese(II), zinc, iron(II), aluminum, gallium, niobium(II), manganese(III) iron(III), zirconium, manganese(IV), silicon, niobium(V), tantalum, and bismuth(V).

Titanium(IV) sites may be occupied, for example, by zirconium, manganese(IV), and/or silicon, and/or by aluminum, gallium, niobium(III), manganese(III), and/or iron(III) and niobium(V), tantalum, and/or bismuth(V).

Within the scope of another specific embodiment, the solid electrolyte which is conductive for sodium ions and nonconductive for electrons includes a sodium titanate tetravalent titanium, in particular a sodium titanate of general formula (2):

Na₂Ti^{IV}ₙO₂ₙ₊₁:MO,

where 2≦n≦10 and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide, i.e., Na₂Ti^{IV}ₙO₂ₙ₊₁, where 2≦n≦10. In particular, the solid electrolyte which is conductive for sodium ions and nonconductive for electrons may be composed of this type of sodium titanate. Sodium titanates of tetravalent titanium, such as Na₂Ti^{IV}ₙO₂ₙ₊₁, where 2≦n≦10, have proven to be advantageous in particular as solid electrolytes which are conductive for sodium ions and nonconductive for electrons.

Within the scope of another specific embodiment, the anode is made of metallic sodium or a sodium alloy, in particular metallic sodium. A high maximum voltage may he advantageously achieved in this way.

Within the scope of another specific embodiment, the chalcogen is sulfur and/or oxygen, in particular sulfur. The solid electrolyte which is conductive for sodium ions and electrons may in particular be infiltrated with the chalcogen.

With regard to further features and advantages of the sodium-chalcogen cell according to the present invention, explicit reference is hereby made to the explanations in conjunction with the method according to the present invention and the description of the figures.

A further subject matter of the present invention relates to a method for producing a sodium-chalcogen cell according to the present invention including the following method steps:
a) providing a conducting element composed of a solid electrolyte which is conductive for sodium ions and electrons, and
b) forming solid electrolyte structures, in particular solid electrolyte crystals, on the conducting element, in particular by hydrothermal synthesis,
   the solid electrolyte structures, in particular solid electrolyte crystals, formed in method step b) being conductive for sodium ions and electrons, or being converted into solid electrolyte structures, in particular solid electrolyte crystals, which are conductive for sodium ions and electron structures, in a method step c). For example, the solid electrolyte structures, in particular solid electrolyte crystals, formed in method step b) may be needle-shaped.

The conductivity of sodium ions and electrons and/or the crystal structure of the solid electrolyte crystals may be adjusted in method step b), for example, via the temperature, the pressure, the duration, and/or the solvent of the hydrothermal synthesis. The conversion into solid electrolyte crystals which are conductive for sodium ions and electrons may he carried out in method step c), for example by thermal treatment or sintering, for example at a temperature in a range of ≧400° C. to ≦1100° C., and/or under reducing conditions, for example under a hydrogen-containing atmosphere.

The conducting element may likewise be produced by hydrothermal synthesis, optionally with a subsequent conversion method step. For example, a solid which is conductive for sodium ions and electrons may initially be produced, which is subsequently formed into the conducting element via a pressing process, for example.

The hydrothermal synthesis may be carried out in particular in an autoclave, for example. For synthesizing sodium titanates, for example metallic, titanium and/or a titanium-containing metal mixture or metal alloys, and/or one or multiple titanium compound(s), for example titanium oxide and/or titanium nitride, may be reacted at a temperature in a range of ≧130° C., to ≦210° C. for example, in an aqueous sodium hydroxide solution having a concentration, for example, in a range of ≧5 mol/L to 15 mol/L, for example. The reaction time may be from ≧1 h to <72 h, for example.

The reaction product may subsequently be filtered off and optionally washed and dried. Tetravalent titanium may be at least partially converted into trivalent titanium by a thermal treatment, in particular under reducing conditions, for example under a hydrogen-containing atmosphere, The electron conductivity of the solid electrolyte may advantageously be adjusted in this way.

With regard to further features and advantages of the method according to the present. invention, explicit reference is hereby made to the explanations in conjunction with the sodium-chalcogen cell according to the present invention and the description of the figures.

### BRIEF DESCRIPTION OF THE DRAWINGS

FIG. 1 shows a schematic cross section of one specific embodiment of a sodium-chalcogen cell according to the present invention.

FIG. 2 shows an enlargement of the area marked in FIG. 1.

### DETAILED DESCRIPTION

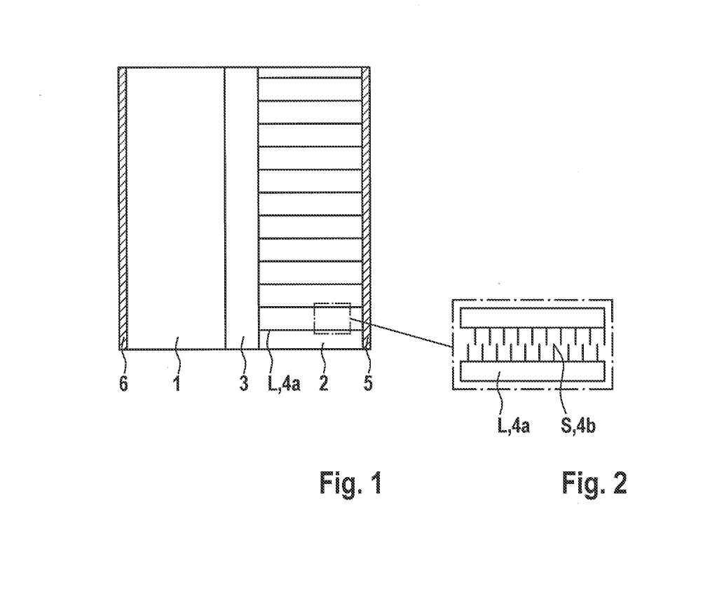

FIG. 1 shows that the sodium-chalcogen cell has an anode 1 containing sodium and a cathode 2 containing sulfur or oxygen. FIG. 1 further illustrates that anode 1 has an anode current collector 6, and cathode 2 has a cathode current collector 5. FIG. 1 shows in particular that anode 1 and cathode 2 are separated. by a sodium ion conductor 3 which is conductive for sodium ions and nonconductive for electrons. Solid electrolyte 3 which is conductive for sodium ions and nonconductive for electrons may be made, for example, of polycrystalline β-aluminate, polycrystalline textured β-aluminate, a sodium titanate tetravalent titanium, for example of general formula (2), or a composite of β-aluminate and a sodium titanate of tetravalent titanium, for example of general formula (2).

FIG. 1 further illustrates that within the scope of this specific embodiment, cathode 2 includes a plurality of conducting elements L composed of a solid electrolyte 4a which is conductive for sodium ions and electrons, one section of which in each case contacts solid electrolyte 3 which is conductive for sodium ions and nonconductive for electrons, and another section of which contacts cathode current collector 5.

FIG. 2 shows that within the scope of this specific embodiment, structures S composed of a solid electrolyte 4b which is conductive for sodium ions and electrons are provided on conducting elements L. These may be, for example, needle-shaped solid electrolyte crystals which are conductive for sodium ions and electrons. These structures may be provided on conducting elements L with the aid of hydrothermal synthesis, for example. Conducting elements L and structures S may be composed, for example, of a solid electrolyte which is conductive for sodium ions and electrons, and which includes a sodium titanate containing trivalent titanium, for example of general formula (1).

1.-12. (canceled)

13. A sodium-chalcogen cell, comprising:
an anode;
a cathode;
at least one first solid electrolyte that is conductive for sodium ions and nonconductive for electrons; and
at least one second solid electrolyte that is conductive for sodium ions and electrons, wherein:
the anode includes sodium,
the cathode includes at least one chalcogen,
the anode and the cathode are separated by the at least one first solid electrolyte, and
the cathode includes the at least one second solid electrolyte.

14. The sodium-chalcogen cell as recited in claim 13, wherein the sodium-chalcogen cell is one of a sodium-sulfur cell and a sodium-oxygen cell.

15. The sodium-chalcogen cell as recited in claim 13, wherein the cathode includes at least one conducting element that includes one of the at least one second solid electrolyte that is conductive for sodium ions and electrons.

16. The sodium-chalcogen cell as recited in claim 15, wherein:
a first section of the at least one conducting element contacts the at least one first solid electrolyte that is conductive for sodium ions and nonconductive for electrons, and
a second section of the at least one conducting element contacts a cathode current collector.

17. The sodium-chalcogen cell as recited in claim 13, wherein:
the cathode includes a plurality of conducting elements that include a solid electrolyte which is conductive for sodium ions and electrons,
a first section of the plurality of conducting elements contacts the at least one first solid electrolyte that is conductive for sodium ions and nonconductive for electrons, and
a second section of the plurality of conducting elements contacts a cathode current collector.

18. The sodium-chalcogen cell as recited in claim 16, further comprising:
structures composed of the solid electrolyte which is conductive for sodium ions and electrons and provided on the conducting element.

19. The sodium-chalcogen cell as recited in claim 18, wherein the structures are formed by needle-shaped, solid electrolyte crystals which are conductive for sodium ions and electrons.

20. The sodium-chalcogen cell as recited in claim 13, wherein the at least one second solid electrolyte that is conductive for sodium ions and electrons includes a sodium titanate that contains trivalent titanium.

21. The sodium-chalcogen cell as recited in claim 13,
wherein the at least one second solid electrolyte that is conductive for sodium ions and electrons includes a sodium titanate of general formula (1):
Na₂Ti^{IV}ₙ₋ₓTi^{III}ₓO_{2n+1-x/2}:MO,
where 2≦n≦10 and 0≦x≦n, and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide.

22. The sodium-chalcogen cell as recited in claim 13, wherein the at least one first solid electrolyte that is conductive for sodium ions and nonconductive for electrons includes a material selected from the group composed of β-aluminum oxide, sodium titanates of tetravalent titanium, for example of general formula (2): Na₂Ti^{IV}ₙO₂ₙ₊₁:MO, where 2≦n≦10 and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide, or mixtures.

23. The sodium-chalcogen cell as recited in claim 22, wherein the β-aluminum oxide includes textured β-aluminum oxide.

24. The sodium-chalcogen cell as recited in claim 22, wherein the mixtures corresponds to composites thereof

25. The sodium-chalcogen cell as recited in claim 13, wherein the at least one first solid electrolyte that is conductive for sodium ions and nonconductive for electrons includes a sodium titanate of general formula (2):
Na₂Ti^{IV}ₙO₂ₙ₊₁:MO,
where 2≦n≦10 and MO stands for one or multiple foreign atom oxides selected from the group composed of Na₂O, Li₂O, MgO, CaO, BaO, MnO, ZnO, FeO, Ti₂O₃, Al₂O₃, Ga₂O₃, Nb₂O₃, Mn₂O₃, Fe₂O₃, ZrO₂, MnO₂, SiO₂, Nb₂O₅, Ta₂O₅, and Bi₂O₅, or for no foreign atom oxide.

26. The sodium-chalcogen cell as recited in claim 13, wherein:
the anode includes one of metallic sodium and a sodium alloy, and
the chalcogen includes one of sulfur and oxygen.

27. The sodium-chalcogen as recited in claim 26, wherein the chalcogen includes sulfur.

28. A method for producing a sodium-chalcogen cell as recited in claim 13, comprising:
providing a conducting element that includes a solid electrolyte that is conductive for sodium ions and electrons, and
forming solid electrolyte structures on the conducting element, wherein the solid electrolyte structures are one of conductive for sodium ions and electrons, and converted into solid electrolyte structures which are conductive for sodium ions and electrons.

29. The method as recited in claim 28, wherein the forming step is performed by hydrothermal synthesis.
